(19) United States
(12) Patent Application Publication
(10) Pub. No.: US 2017/0342703 A1
(43) Pub. Date: Nov. 30, 2017

(54) PLUG AND PLAY FOLDING BUILDING SYSTEM

(71) Applicant: FOLDING HOLDINGS LLC, Woodinville, WA (US)

(72) Inventors: Elliot Peterson, Woodinville, WA (US); Douglas Peterson, Woodinville, WA (US)

(21) Appl. No.: 15/605,918

(22) Filed: May 25, 2017

Related U.S. Application Data
(60) Provisional application No. 62/342,804, filed on May 27, 2016.

(51) Int. Cl. E04B 1/343; H02G 3/30; H01R 24/28; H02K 11/30; H01R 24/20; E04B 1/41; H02K 7/14; H01R 24/76; H01R 103/00

(52) U.S. Cl. CPC E04B 1/34357; H02K 7/14; H02G 3/30; H01R 24/28; H01R 24/76; H02K 11/30; H01R 24/20; E04B 1/40; E04B 1/34384; E04B 1/34336; H01R 2103/00

(57) ABSTRACT

A building system in which each panel of each four-panel foldable section and each end panel has preinstalled wiring with plug and play connectors at least at the electrical wiring limits of each such panel. Preferably, each wall panel has a prewired lighting circuit and a prewired convenience electrical outlet. Particular panels may have additional wiring variously for the switch box, the service door motors, fans, and the incoming primary electrical power source. The plug and play connectors for connecting between panels and between panels within four-panel sections include slack cable ends that enable the plug and play connectors to be stowed and secured (tape, bundle ties, etc.) during transport and storage of the folding building. Preferably, field-installed cable trays run the length of the building and field-installed cabling therein connects to preinstalled wiring using plug and play connectors.

### RELATED APPLICATIONS

This application claims the benefit of U.S. provisional patent application 62/342,804 filed May 27, 2016 for the same inventors.

### TECHNICAL FIELD

This invention relates to providing a folding steel building, and variants thereof, including individual wall panels or roof panels, with pre-installed electrical wiring. This invention more particularly relates to a folding building made of foldable prefabricated transverse four-panel hinged sections in which two panels are roof panels and two panels are wall panels. Electrical connectors that plug into each other and latch are used between panels and between sections.

### BACKGROUND

U.S. Pat. No. 9,222,250 to the same inventor discloses a foldable building that is the structural basis for the present application and the entire disclosure therein is included herein by reference.

Once a building is erected according to U.S. Pat. No. 9,222,250, substantial field effort must be expended to add an electrical system for the building. Since such buildings are often used in remote locations (above the arctic circle, for example) the cost of field labor is substantial. Pre-wiring the building, which would reduce labor costs and improve reliability, is complicated by the fact that the building is made of folded sections. To keep the field labor costs low, electrical connections must be made fast and simple.

Therefore, a need exists for folding buildings that have prewired electrical systems that are compatible with a foldable steel building and which can be rapidly and economically assembled.

### OBJECTS AND FEATURES OF THE INVENTION

A primary object and feature of the present invention is to overcome the above-mentioned problems and fulfill the above-mentioned needs.

Another object and feature of the present invention is to provide prewired electrical circuitry on multiple panels and multiple sections.

Another object and feature of the present invention is to provide quick connect/quick disconnect (hereinafter “plug and play”) multi-wire electrical connectors at the electrical boundaries of multiple panels and multiple sections.

It is a further object and feature of the present invention to provide cabling allowing the electrical connectors to be stowed during storage and transport of the folding building, in such a way as to avoid damage to connectors from folding the four-panel building sections.

It is a further object and feature of the present invention to provide field-installed elements of the electrical system that cannot be installed on panels when the building is folded for storage or transport.

It is a further object and feature of the present invention to provide cable trays, cable tray brackets, and a switch box for field installation.

It is a further object and feature of the present invention to provide plug and play electrical connectors at the input and outputs of the switch box.

It is a further object and feature of the present invention to provide pre-installed lighting fixtures with pre-installed wiring on multiple panels.

It is a further object and feature of the present invention to provide end panels having pre-installed wiring for service doors, exhaust fans, and lighting personnel access doors.

It is a further object and feature of the present invention to provide pre-wired and pre-installed electrical convenience outlets on multiple panels.

It is a further object and feature of the present invention to provide pre-wired and pre-installed electrical switches on multiple panels.

It is an additional primary object and feature of the present invention to provide such improvements that are efficient, inexpensive and handy. Other objects and features of this invention will become apparent with reference to the following descriptions.

### SUMMARY OF THE INVENTION

A building system in which panels of each four-panel foldable section and each end panel has preinstalled wiring with plug and play connectors at least at the electrical wiring limits of each such panel. Preferably, each wall panel has a prewired lighting circuit and a prewired convenience electrical outlet. Particular panels may have additional wiring variously for the switch box, the service door motors, fans, and the incoming primary electrical power source. The plug and play connectors for connecting between panels and between panels within four-panel sections include slack cable ends that enable the plug and play connectors to be stowed and secured (tape, bundle ties, etc.) during transport and storage of the folding building. Field-installed cable trays run the length of the building and field-installed cabling therein connects to preinstalled wiring using plug and play connectors.

### BRIEF DESCRIPTION OF THE DRAWINGS

The present invention will hereinafter be described in conjunction with the following drawing figures, wherein like numerals denote like elements, and

FIG. 1 is a front perspective view illustrating a first exemplary embodiment of a partial wall panel of an exemplary plug and play folding building system, according to a preferred embodiment of the present invention;

FIG. 2 is an end elevation view illustrating the first exemplary embodiment of a partial cross section of the exemplary plug and play folding building system of FIG. 1, according to a preferred embodiment of the present invention;

FIG. 3A is a side elevation view illustrating an exemplary plug and play connector of the exemplary plug and play folding building system of FIG. 1 in a pre-connected configuration, according to a preferred embodiment of the present invention;

FIG. 3B is a side elevation view illustrating an exemplary plug and play connector of the exemplary plug and play folding building system of FIG. 1 in a connected configuration, according to a preferred embodiment of the present invention;

FIG. 3C is a side elevation view illustrating an exemplary plug and play connector of the exemplary plug and play folding building system of FIG. 1 in a connected and latched configuration, according to a preferred embodiment of the present invention;

FIG. 4 is a front perspective view illustrating a detail of an exemplary embodiment of partial panels and power distribution circuitry of the exemplary plug and play folding building system of FIG. 1, according to a preferred embodiment of the present invention;

FIG. 5 is a front elevation view illustrating an exemplary embodiment of a first wiring of a wall panel of the exemplary plug and play folding building system of FIG. 1, according to a preferred embodiment of the present invention;

FIG. 6 is a front elevation view illustrating an exemplary embodiment of a second wiring of a wall panel of the exemplary plug and play folding building system of FIG. 1, according to a preferred embodiment of the present invention;

FIG. 7 is an end elevation x-ray view illustrating an exemplary embodiment of the exemplary plug and play folding building system of FIG. 1, and defining cross sections AA and BB, according to a preferred embodiment of the present invention;

FIG. 8 is a side elevation x-ray view illustrating an exemplary embodiment of the exemplary plug and play folding building system of FIG. 1, and defining cross sections CC, DD, EE, and FF, according to a preferred embodiment of the present invention;

FIG. 9 is a front elevation view of cross section AA illustrating an exemplary embodiment of a series of wall panels of the exemplary plug and play folding building system of FIG. 1, and defining detailed section G, according to a preferred embodiment of the present invention;

FIG. 10 is a front elevation view of cross section BB illustrating an exemplary embodiment of a series of wall panels of the exemplary plug and play folding building system of FIG. 1, according to a preferred embodiment of the present invention;

FIG. 11 is a front elevation view illustrating an exemplary embodiment of preinstalled wiring on a detailed section G of a wall panel of the exemplary plug and play folding building system of FIG. 1, according to a preferred embodiment of the present invention;

FIG. 12 is a front elevation view illustrating an exemplary embodiment of preinstalled and field-installed wiring on a detailed section G of the wall panel of FIG. 12 of the exemplary plug and play folding building system of FIG. 1, according to a preferred embodiment of the present invention;

FIG. 13 is an end elevation view through section CC illustrating an exemplary embodiment of the exemplary plug and play folding building system of FIG. 1, according to a preferred embodiment of the present invention;

FIG. 14 is an end elevation view through section DD illustrating an exemplary embodiment of the exemplary plug and play folding building system of FIG. 1, according to a preferred embodiment of the present invention;

FIG. 15 is an end elevation view through section EE illustrating an exemplary embodiment of the exemplary plug and play folding building system of FIG. 1, according to a preferred embodiment of the present invention; and

FIG. 16 is an side elevation view through section FF illustrating an exemplary embodiment of the cable tray of the exemplary plug and play folding building system of FIG. 1, according to a preferred embodiment of the present invention.

### DETAILED DESCRIPTION OF THE PRESENT INVENTION

As defined and used herein, the words “cable”, “line”, and “lead” all refer to electrical conductors. As defined and used herein, the word “prewired” means installed at the factory, as opposed to installed in the field. As defined and used herein, the word “ceiling” refers to the interior surfaces of roof panels.

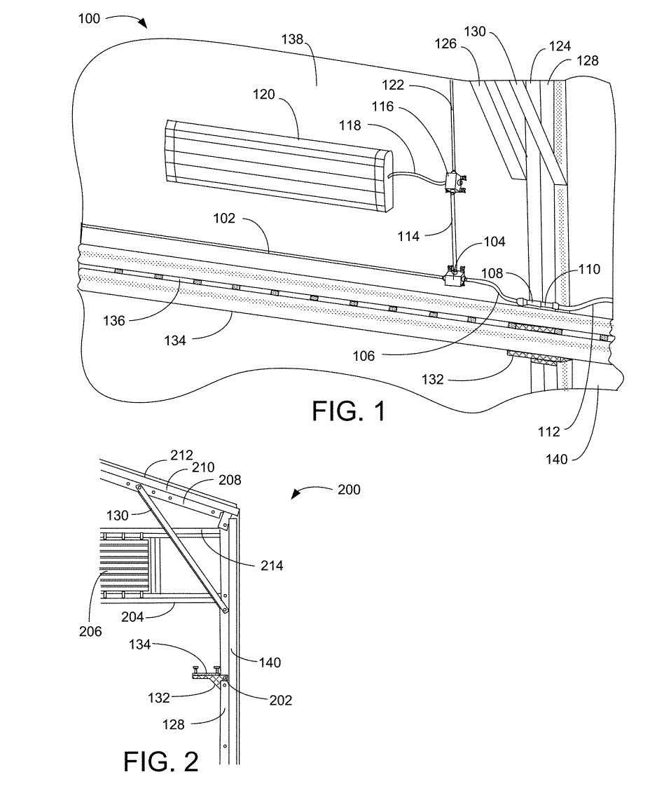

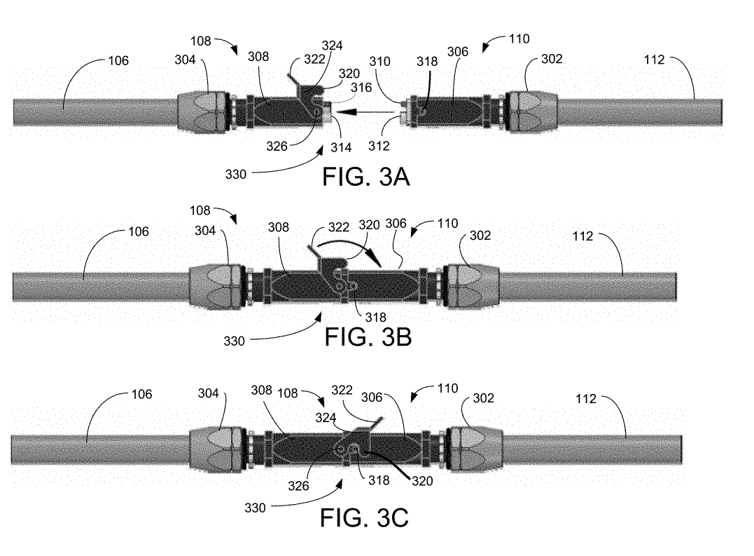

FIG. 1 is a front perspective view illustrating a first exemplary embodiment of partial wall panels 138 and 140 of an exemplary plug and play folding building system 100, according to a preferred embodiment of the present invention. Exemplary wall panels 138 and 140 may be configured as any embodiment claimed and described in U.S. Pat. No. 9,222,250 and obvious variations thereof. Exemplary wall panel 138 is part of a four-panel folding building section comprising two wall panels and two roof panels, each section foldably connected for storage and transportation. Exemplary wall panel 140 is part of an adjacent four-panel folding building section comprising two wall panels and two roof panels, each section foldably connected for storage and transportation. The panels 138 and 140 are joined together at columns 124 and 128, preferably by bolts. Panel 138 supports prewired (installed at the factory) lighting circuit main 102, along with first prewired electrical T-coupling 104, prewired slack-end cable 106 to female half 108 of connector 330 (see FIG. 3A-C), second prewired electrical T-coupling 116, prewired lighting circuit lead 114 between first and second prewired T-couplings 104 and 116, prewired lead 118 from second T-coupling 116 to prewired light fixture 120, and prewired lighting circuit extension 122.

Prewired slack-end cable 106 to female half 108 of connector 330 (see FIG. 3A-C) allows the female half 108 of plug and play connector 330 (see FIG. 3) to be stowed against panel 138 for transportation and storage, and then extended across column 124 to connect with the prewired male half 110 of plug and play connector 330 coupled to prewired slack-end cable 112 secured to panel 140. All prewired elements 102, 104, 106, 108, 110, 112, 114, 116, 118, 120, and 122 are sized and configured to not interfere with folding and unfolding of their respective folding building sections.

Cable tray 134 is installed in the field and is supported by cable tray brackets 132 (one shown in this view) that are fastened to each adjoining pair of columns 124 and 128. Cable tray 134 runs the length of the building and supports long runs of field-installed cables that connect to prewired circuits. Cable tray 134 has a series of openings 136 (only one of many labeled) in the tray bottom to assist in making connections below the cable tray 134. Corner braces 126 and 130 are field-installed between columns 124 and 128 and rafters (not shown in this view) of their respective sections. An advantage of the present invention is that all of the wiring that can be done at the factory, and that is compatible with a folding building section, is installed economically at the factory, and is easily accessible for the parts that must be installed in the field.

FIG. 2 is an end elevation view illustrating the first exemplary embodiment of a partial cross section 200 of the plug and play folding building system 100 of FIG. 1, according to a preferred embodiment of the present invention. Fastener 202 fastens cable tray bracket 132 to columns 128 and 124, preferably using a single bolt through the columns 128 and 124. Far end panel girts 204 and 214 support ventilation louvers 206. Corner brace 130 is better shown connected between column 128 and rafter 208. Rafter 208 is part of roof panel 210 which also supports roof flashing 212.

FIG. 3A is a side elevation view illustrating an exemplary plug and play connector 330 of the exemplary plug and play folding building system 100 of FIG. 1 in a pre-connected configuration, according to a preferred embodiment of the present invention. Prewired slack-end cable 106 to female half 108 of connector 330 (see FIG. 3C) ends in a coupling 304 to the female side connector body 308, which supports sockets 314 and 316. Sockets 314 and 316 may, in various embodiments, have multiple pin-receiving connectors corresponding to individual wires in respective cables. In various embodiments, more or fewer sockets 314 and 316 may be used. Female side connector body 308 supports latch 324 that is manually rotatable about latch pivot 326. Latch 324 features latch lever 322 and latch cam 320. Prewired slack-end cable 112 to male half 110 of connector 330 (see FIG. 3C) ends in a coupling 302 to the male side connector body 306, which supports plugs 310 and 312. Plugs 310 and 312 may, in various embodiments, have multiple pin connectors corresponding to individual wires in respective cables. In various embodiments, more or fewer plugs 310 and 312 may be used. Plugs 310 and 312 are configured to be inserted in sockets 316 and 314, respectively. Male side connector body 306 supports latch pin 318.

FIG. 3B is a side elevation view illustrating an exemplary plug and play connector 330 of the exemplary plug and play folding building system 100 of FIG. 1 in a connected configuration, according to a preferred embodiment of the present invention. Plugs 310 and 312 have been inserted into sockets 316 and 314, respectively, and female side connector body 308 abuts male side connector body 306 with a water-resistant seal there between.

FIG. 3C is a side elevation view illustrating an exemplary plug and play connector 330 of the exemplary plug and play folding building system 100 of FIG. 1 in a connected and latched configuration, according to a preferred embodiment of the present invention. Lever 322 has been manually moved in the direction indicated by the arrow in FIG. 3B, causing the latch cam 320 to capture the latch pin 318, thereby latching the plug and play connector 330 in a connected configuration. An advantage of the present invention is that plug and play connector 330 can be connected by users wearing thick gloves, arctic mittens, or similar protective gear. Plug and play connectors 330 are used at multiple locations in the present invention, including at panel-to-panel connections, section-to-section connections, and intra panel connections between field-installed lines and prewired lines, generally. Plug and play connectors 330 are merely exemplary, and various other connectors of similar functionality may be used in respective various embodiments.

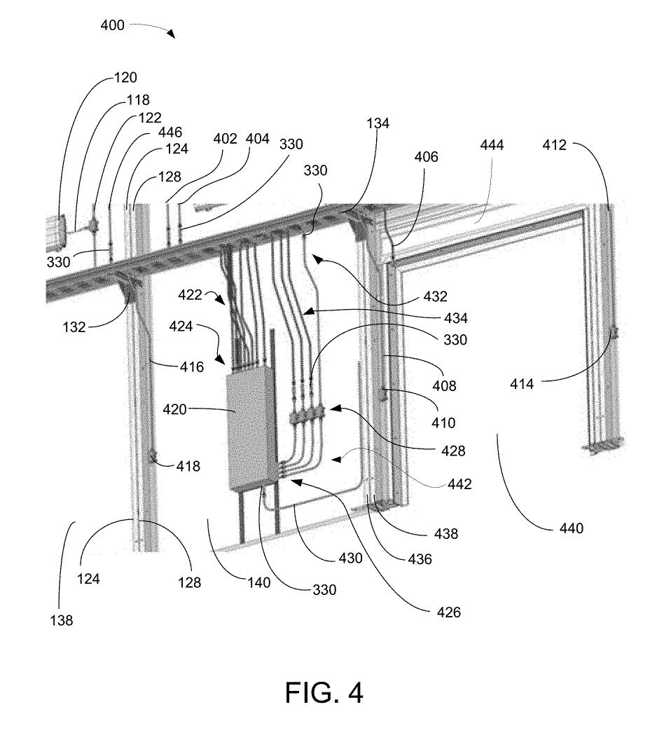

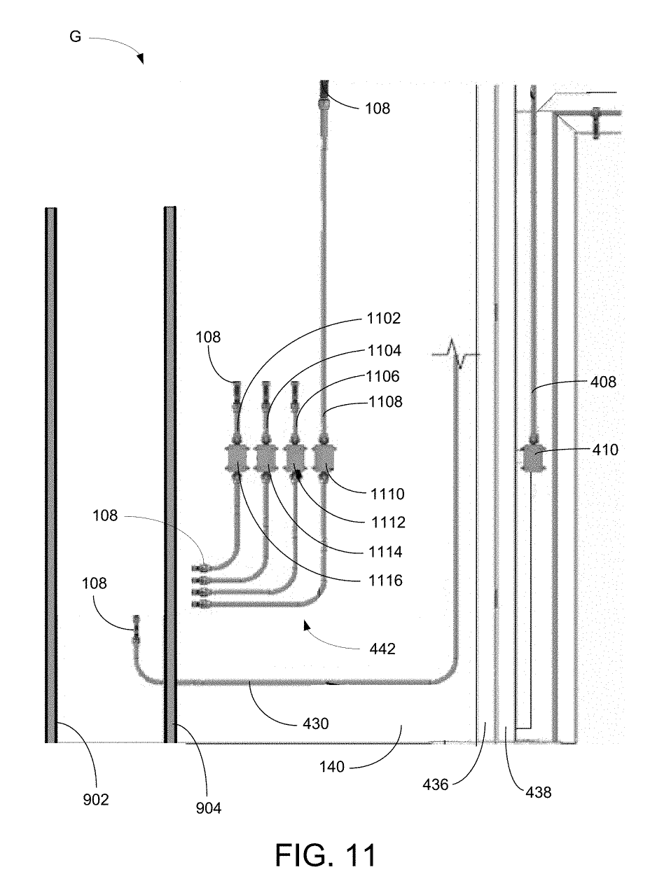

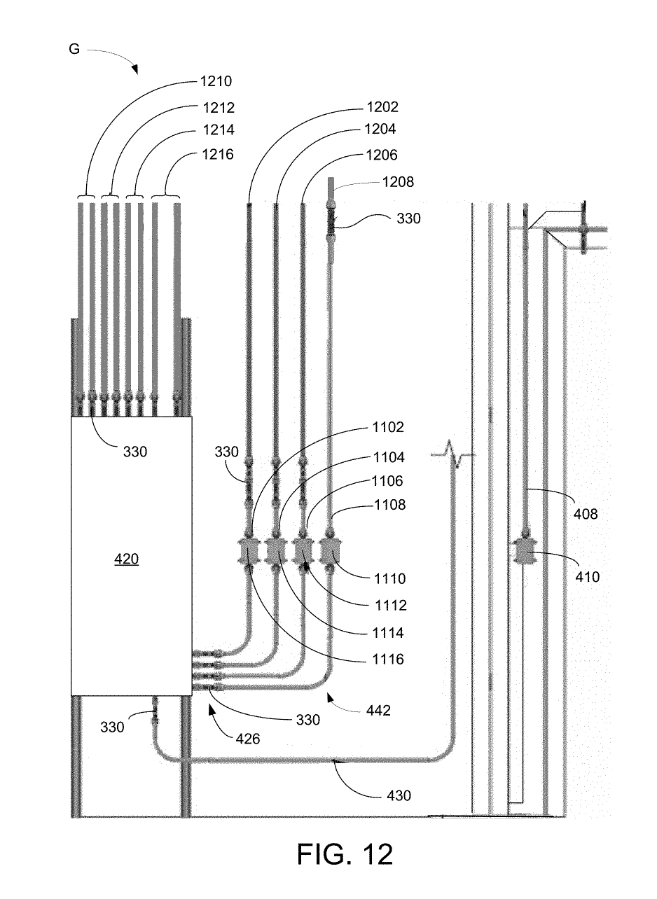

FIG. 4 is a front perspective view illustrating a detail of an exemplary embodiment of partial panels 138, 140, and 444 and power distribution circuitry 400 of the exemplary plug and play folding building system 100 of FIG. 1, according to a preferred embodiment of the present invention. FIG. 4 illustrates a combination of field-installed circuitry (i.e. distribution box 420) and prewired circuitry (i.e. connectors 330). The prewired circuitry includes first prewired convenience power roof run 402; second prewired convenience power roof run 404; prewired service door power line 406; prewired service door switch line 408; prewired service door switch 410; first prewired convenience power extension 412; first prewired convenience power outlet 414; second prewired convenience power extension 416; second prewired convenience power outlet 418; male portions 110 of prewired power distribution plug and play switchable power connectors 330, collectively 426; prewired power switches 1110, 1112, 1114, and 1116, (see FIG. 11) collectively 428; prewired power source line extension 430; prewired ceiling fan line 432; prewired distribution out cables 442; and prewired fan power source line 446. Field-installed circuitry includes field-installed distribution box 420; field-installed power distribution output cables 1210, 1212, 1214, and 1216 (see FIG. 12), collectively 422; field-installed power distribution plug and play power connectors 330, collectively 424; and field-installed switchable power lines 1202, 1204, and 1206 (see FIG. 12), collectively 434. Connections between field-installed circuitry and prewired circuitry is via plug and play connectors 330. This includes connections between rewired panel circuitry (402, 404, 406, 408, 412, 416, 430, and 432), and field-installed cables in field-installed cable tray 134. Cable tray 134 cables can be seen extending through tray bottom openings 136. Field-installed cables are prefabricated and include correct sizing and terminate with appropriate halves 108 or 110 of plug and play connector 330. The advantage of having plug and play connectors 330 for all connections between field-installed cables and prewired lines is in the speed of assembly at the construction site. FIG. 4 also illustrates a doorway in panel 444 and panel 140 right column 436 bolted to panel 444 left column 438.

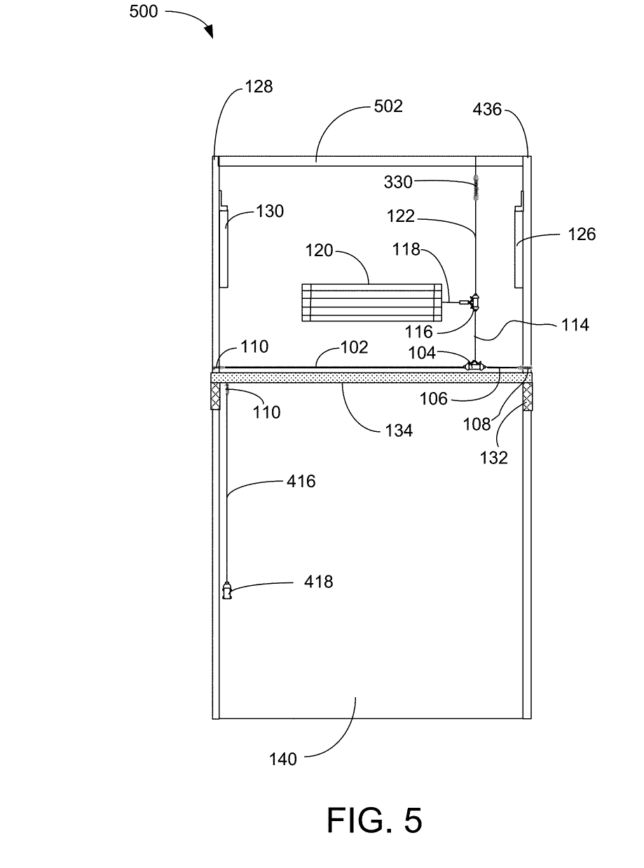

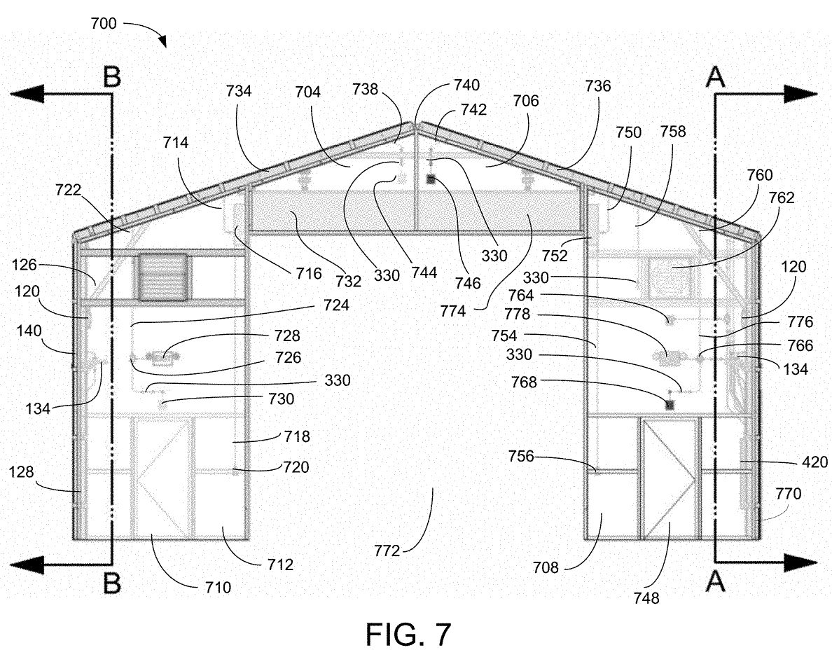

FIG. 5 is a front elevation view illustrating an exemplary embodiment of a first wiring 500 of an exemplary wall panel 140 of the exemplary plug and play folding building system 100 of FIG. 1, according to a preferred embodiment of the present invention. FIG. 5 illustrates a basic prewired panel 140 with the field-installed cable tray 134 added. Top girt 502 connects left and right columns 128 and 436, respectively. Each wall panel, including wall panel 140, includes a prewired lighting circuit main 102, a first prewired electrical T-coupling 104, a prewired slack-end cable 106 to female half 108 of a connector 330 (see FIG. 3A-C) on the right side and a male half 110 of a connector 330 (see FIG. 3A-C) extending from prewired lighting circuit main 102 on the left side. In a particular embodiment, the male and female halves 108 and 110 of connectors 330 may be reversed, but the convention must be consistent for all wall panels in all sections, and compatible with end panels 708 and 712 (see FIG. 7). Each panel preferably includes a convenience power outlet 418 coupled to a prewired male half 110 of plug and play connector 330, with the female half being on the convenience power cable in the cable tray.

The lighting circuit extends from first prewired electrical T-coupling 104 via line 114 to second prewired electrical T-coupling 116. Prewired lead 118 extends from second prewired electrical T-coupling 116 to prewired light fixture 120. Prewired lighting circuit extension 122 extends via a plug and play connector 330 to the ceiling lighting circuit.

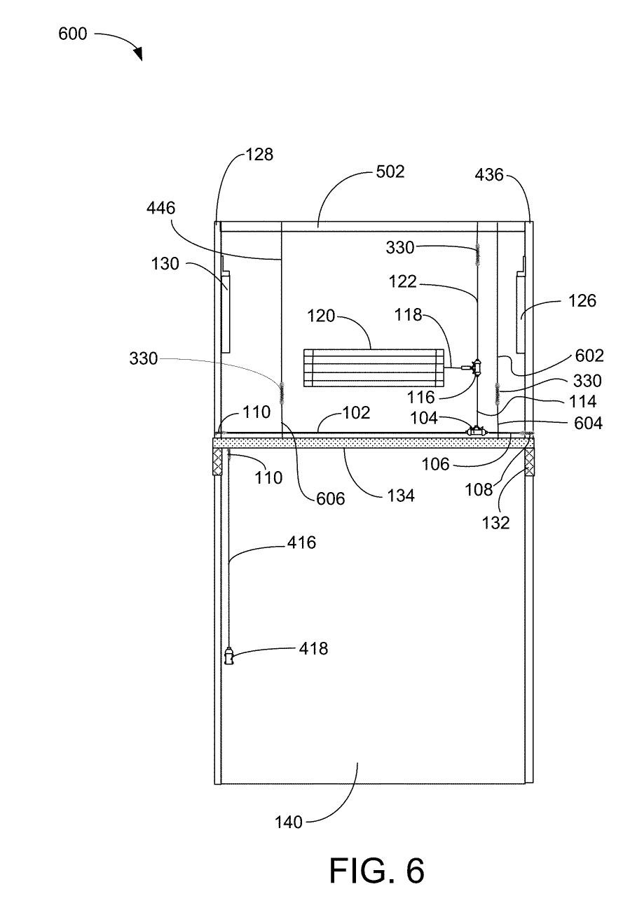

FIG. 6 is a front elevation view illustrating an exemplary embodiment of a second wiring 600 of a wall panel 140 of the exemplary plug and play folding building system 100 of FIG. 1, according to a preferred embodiment of the present invention. FIG. 6 illustrates additions to the circuitry of FIG. 5 for connecting to a primary power source. Prewired primary power line 602 connects via a plug and play connector 330 to field-installed primary power line 604 that extends from the cable tray 134. Prewired fan power source line 446 receives power via a plug and play connector 330 from field-installed fan power line in cable tray 134. All other wall panel circuits are similar to circuits on wall panel 140 in FIG. 5.

FIG. 7 is an end elevation partial x-ray view 700 illustrating an exemplary embodiment of the exemplary plug and play folding building system 100 of FIG. 1, and defining cross sections AA and BB, according to a preferred embodiment of the present invention. Left side end panel 712 is at the far end (from the viewer) of the plug and play folding building system 100. Left side end panel 712 extends to left roof panel 734 and shows a x-ray view of far end personnel access door 710, prewired far end service door motor power 714, far end service door motor 716, prewired far end service door motor switch line 718, prewired far end service door motor switch 720, prewired far end roof drop power extension 722, prewired lighting circuit 724, prewired lighting circuit T-coupling 726, prewired illuminating exit sign 728, and field-installed personnel access door exterior light 730.

Left side top far end panel 704 extends from the top of service doorway 772 to left roof panel 734. Left side top far end panel 704 supports field-installed roll down service door 732, and far end prewired roof drop lighting circuit 738 coupled to far end field-installed exterior service door light 744 via a plug and play connector 330.

Right side end panel 708 is at the near end (to the viewer) of the plug and play folding building system 100. Right side top near end panel 706 extends from the top of service doorway 772 to right roof panel 736. Right side top near end panel 706 supports field-installed roll down service door 774, and near end prewired roof drop lighting circuit 742 coupled to near end field-installed exterior service door light 746 via a plug and play connector 330. Left and right roof panels 734 and 736, respectively, are connected by ridge plate 740.

Right side end panel 708 extends from ground level to right roof panel 736 and shows a near end personnel access door 748, prewired near end service door motor power 750, near end service door motor 774, prewired near end service door motor switch line 754, prewired near end service door motor switch 756, prewired near end roof drop power extension 760, prewired lighting circuit 776, prewired lighting circuit T-coupling 766, prewired illuminating exit sign 778, prewired interior light 764, field-installed personnel access door exterior light 768 coupled to prewired lighting circuit 776 via a plug and play connector 330, and exhaust fan 762 coupled to prewired roof drop fan power extension 758 via a plug and play connector 330.

In some embodiments, less than all of the wall panels 138 and 140, and roof panels 734 and 736 in a section or building are prewired. For example, in a particular embodiment, a wall panel 140 having a distribution box 420, may be the only prewired panel in the section or the building.

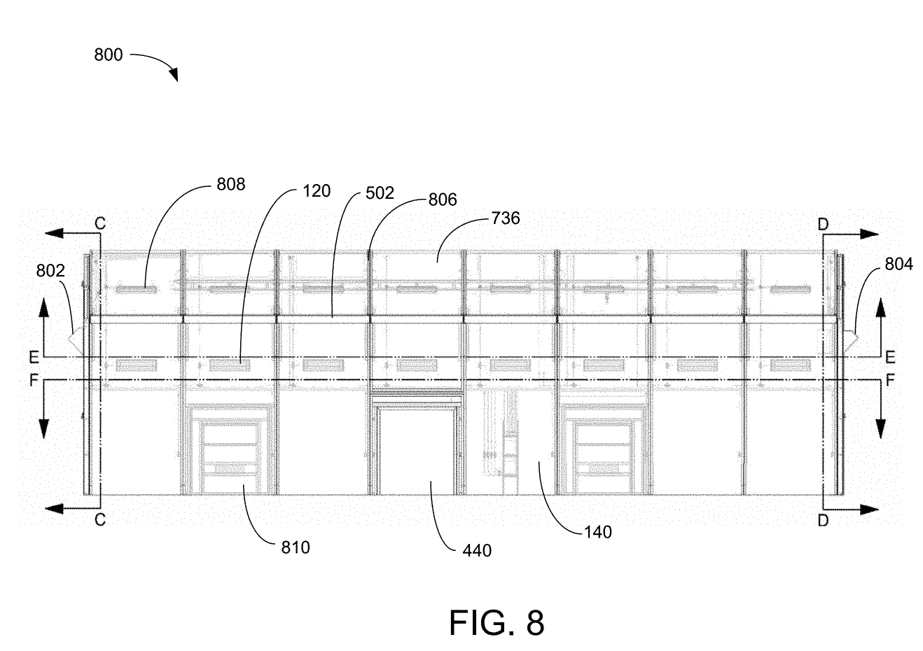

FIG. 8 is a side elevation x-ray view 800 illustrating an exemplary embodiment of the exemplary plug and play folding building system 100 of FIG. 1, and defining cross sections CC, DD, EE, and FF, according to a preferred embodiment of the present invention. FIG. 8 shows a plug and play folding building system 100 having eight sections. In various other embodiments, more or fewer sections may be used. The eight roof panels 736 (one of eight labeled) each support one ceiling light 808 (one of eight labeled), respectively. Roof panels 736 are connected side-by-side by their rafters 806. Ventilation hoods 802 and 804 assist in keeping precipitation from entering through the ventilation system. Wall panels 140 (one of eight labeled) show two wall panels 140 with small service doors 810 (one of two labeled) and one wall panel 140 with a larger service doorway 440.

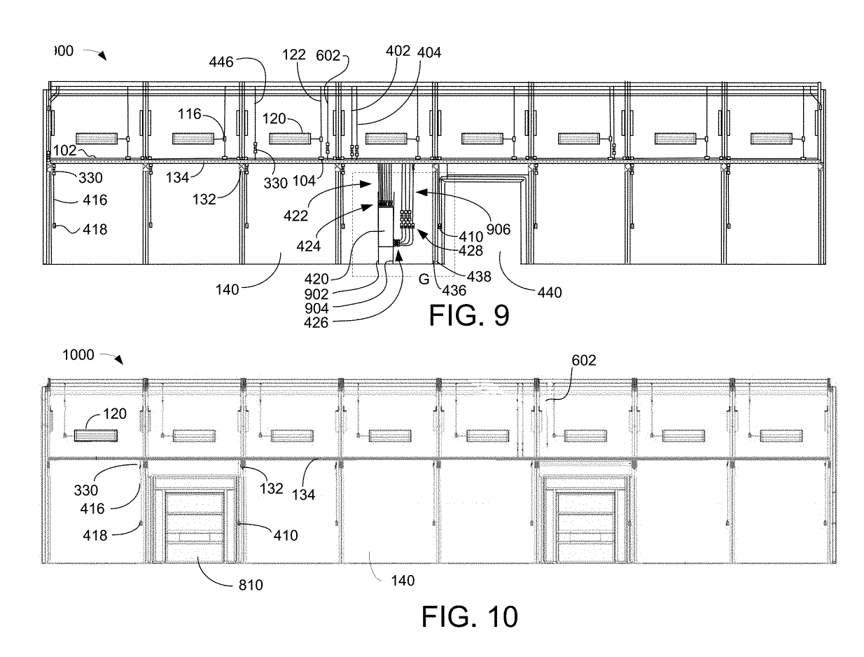

FIG. 9 is a front elevation view of cross section AA illustrating an exemplary embodiment of a series of wall panels 900 of the exemplary plug and play folding building system 100 of FIG. 1, and defining detailed section G, according to a preferred embodiment of the present invention. Left and right mounting rails 902 and 904, respectively, provide for quick mounting of field-installed distribution box 420. Lines 906 include prewired ceiling fan line 432 (shown in FIG. 4) and field-installed switchable power lines 434 (shown in FIG. 4).

FIG. 10 is a front elevation view of cross section BB illustrating an exemplary embodiment of a series of wall panels 1000 of the exemplary plug and play folding building system 100 of FIG. 1, according to a preferred embodiment of the present invention. Prewired primary power line 602 goes along the roof panels to a wall panel on the opposite side of the plug and play folding building system 100, were it can be coupled into a cable in the cable tray 134.

FIG. 11 is a front elevation view illustrating an exemplary embodiment of preinstalled wiring on a detailed section G of wall panel 140 of the exemplary plug and play folding building system 100 of FIG. 1, according to a preferred embodiment of the present invention. Only the prewired circuitry is shown in this view and should be compared with the field-installed view in FIG. 12. Each of the lines that will connect to the field-installed distribution box 420 (not shown in this view) end in prewired female halves 108 of plug and play connectors 330. Wall panel 140 supports prewired first lighting switchable circuit line out 1102, prewired second lighting switchable circuit line out 1104, prewired exhaust fan line out 1106, prewired ceiling fan line out 1108, each of which extends from prewired ceiling fan switch 1110, prewired exhaust fan switch 1112, prewired second lighting circuit switch 1114, and prewired first lighting circuit switch 1116, respectively, and each terminates in a prewired female half 108 of a plug and play connector 330. Respective prewired distribution out cables 442 extend from prewired ceiling fan switch 1110, prewired exhaust fan switch 1112, prewired second lighting circuit switch 1114, and prewired first lighting circuit switch 1116, respectively, and each terminates in a prewired female half 108 (one of four labeled) of a plug and play connector 330 proximate the distribution box right mounting rail 904. Prewired power source line extension 430 is supported on panel 140 and terminates in a prewired female half 108 of a plug and play connector 330 between distribution box right mounting rails 902 and 904. Supporting various wires and components on a wall panel, such as wall panel 140, may be accomplished with various known types of fasteners. For non-limiting examples, screws, clamps, bundle ties, adhesives, tape, and clips may suffice.

FIG. 12 is a front elevation view illustrating an exemplary embodiment of preinstalled and field-installed wiring on a detailed section G of the wall panel 140 of FIG. 12 of the exemplary plug and play folding building system 100 of FIG. 1, according to a preferred embodiment of the present invention. Field-installed distribution box 420 includes complimentary male plug and play connector halves 110 to make pluralities of connectors 330 with prewired circuits on the panel. Field-installed distribution box 420 is configured to quickly mount on distribution box left mounting rail 902 and distribution box right mounting rail 904. Prewired distribution out cables 442 couple to field-installed distribution box 420 via respective plug and play connectors 330 (one of four labeled). Prewired power source line extension 430 provides primary electrical power to distribution box 420 via a plug and play connector 330.

Field-installed first lighting circuit extension 1202, which descends from cable tray 134, is coupled to prewired first lighting switchable circuit line out 1102 via a plug and play connector 330. Field-installed second lighting circuit extension 1204, which descends from cable tray 134, is coupled to prewired second lighting switchable circuit line out 1104 via a plug and play connector 330. Field-installed exhaust fan circuit extension 1206, which descends from cable tray 134, is coupled to prewired exhaust fan line out 1106. Prewired ceiling fan line out 1108 couples to cable tray ceiling fan power line 1208 via a plug and play connector 330.

Field-installed first side convenience power extensions 1210 descend from the cable tray 134 and couples to field-installed distribution box 420 via plug and play connectors 330 (one of eight labeled). Field-installed service door power extensions 1212 descend from the cable tray 134 and couples to field-installed distribution box 420 via plug and play connectors 330. Field-installed end wall power extensions 1214 descend from the cable tray 134 and couples to field-installed distribution box 420 via plug and play connectors 330. Field-installed second side convenience power extensions 1216 descend from the cable tray 134 and couples to field-installed distribution box 420 via plug and play connectors.

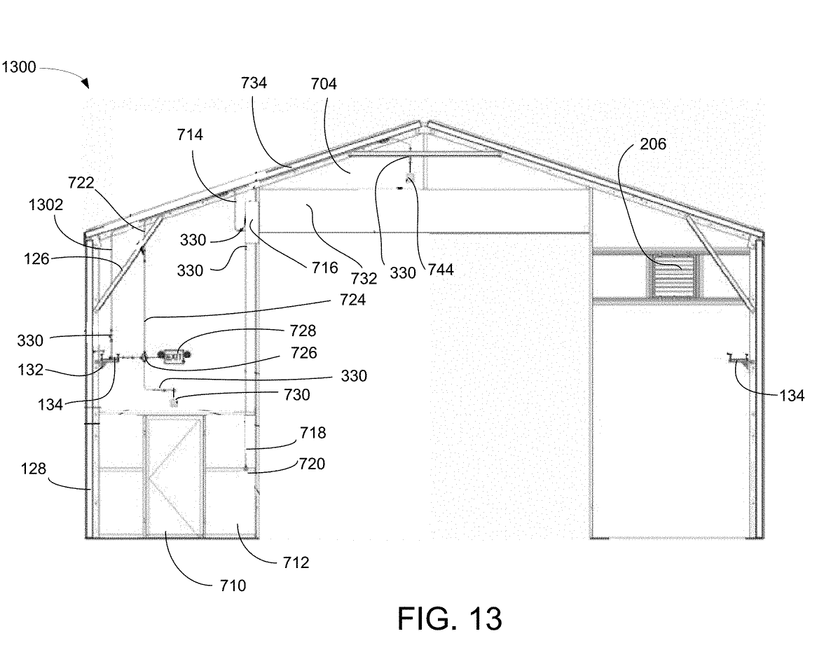

FIG. 13 is an end elevation view through section CC 1300 illustrating an exemplary embodiment of the exemplary plug and play folding building system 100 of FIG. 1, according to a preferred embodiment of the present invention. Prewired end panel roof run 1302 is coupled to power from a line in the cable tray 134 via a plug and play connector 330. Each wall has a cable tray 134 that runs the internal length of the plug and play folding building system 100.

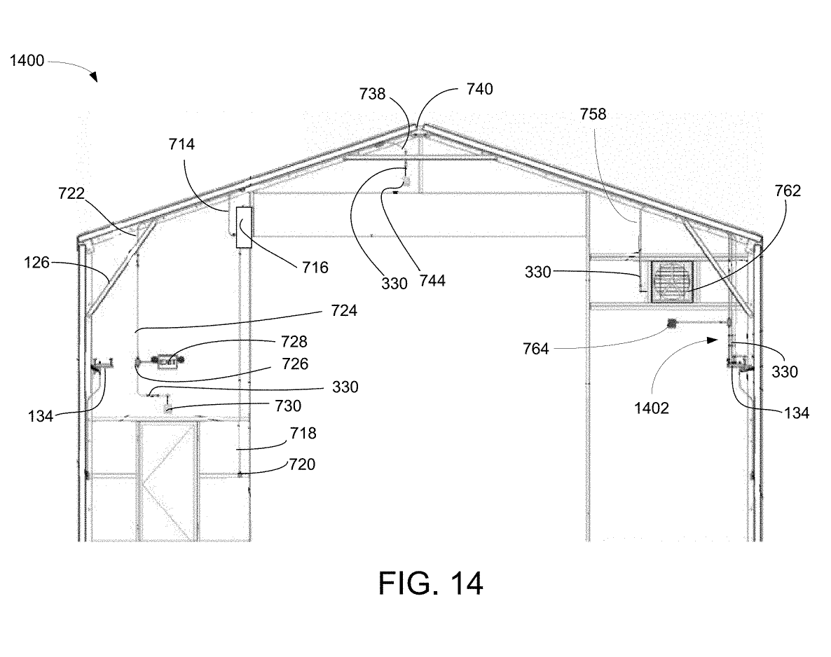

FIG. 14 is an end elevation view through section DD 1400 illustrating an exemplary embodiment of the exemplary plug and play folding building system 100 of FIG. 1, according to a preferred embodiment of the present invention. Prewired end panel power extensions 1402 connect to respective cable tray 134 cables via plug and play connectors 330.

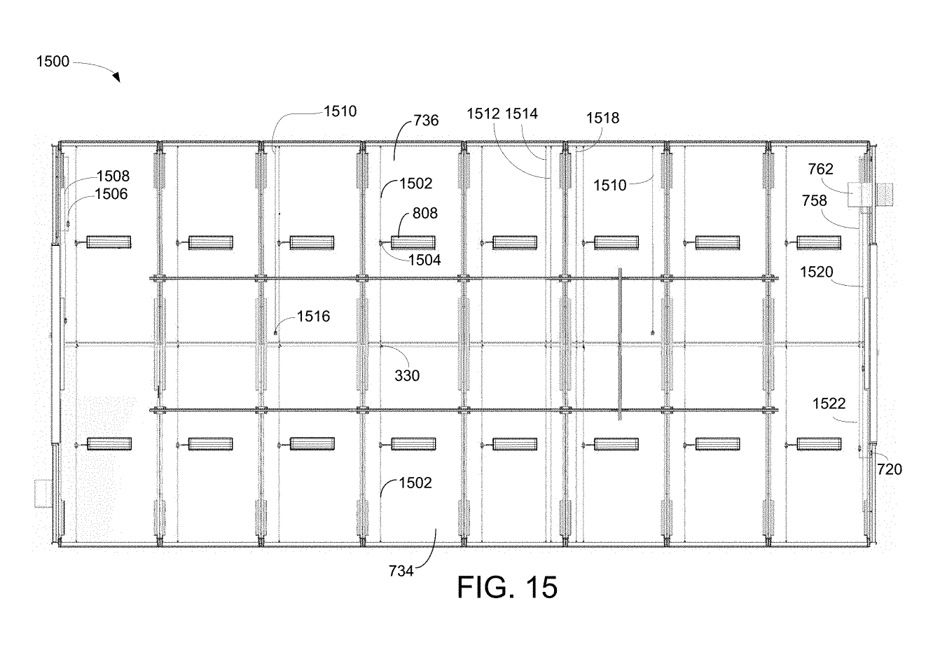

FIG. 15 is an end elevation view through section EE 1500 illustrating an exemplary embodiment of the exemplary plug and play folding building system 100 of FIG. 1, according to a preferred embodiment of the present invention. Prewired ceiling portion of lighting circuit 1502 (one of eight labeled) extends along each ceiling panel 736 (one of eight labeled) and 734 (one of eight labeled) to provide power to ceiling lights 808 (one of sixteen labeled) via prewired ceiling lighting circuit T-couplings 1504 (one of sixteen labeled). Each prewired ceiling portion of lighting circuit 1502 connects across the boundary between each ceiling panel 736 and 734 via a plug and play connector 330 (one of eight cross-ceiling connectors labeled). Ceiling portions of prewired personnel door lighting circuit 1506 and prewired service door lighting circuit 1508 can be seen in this view. Prewired ceiling fan circuit ceiling extension 1510 extends to prewired ceiling fan plug and play connector 1516. Ceiling fans (not shown) are optional. First prewired ceiling run line 1512 and second prewired ceiling run line 1514 carry convenience power from the wall where the primary electrical power enters the building to the opposing wall. First prewired ceiling run line 1512 and second prewired ceiling run line 1514 connect across the roof panel boundary using plug and play connectors 330. Primary power ceiling run 1518 provides primary power from the wall where the primary electrical power enters the building to the opposing wall. Primary power ceiling run 1518 connects across the roof panel boundary using a plug and play connector 330. Ceiling portions of prewired exhaust fan wiring 1520 and prewired service door power line 1522 can be seen in this view.

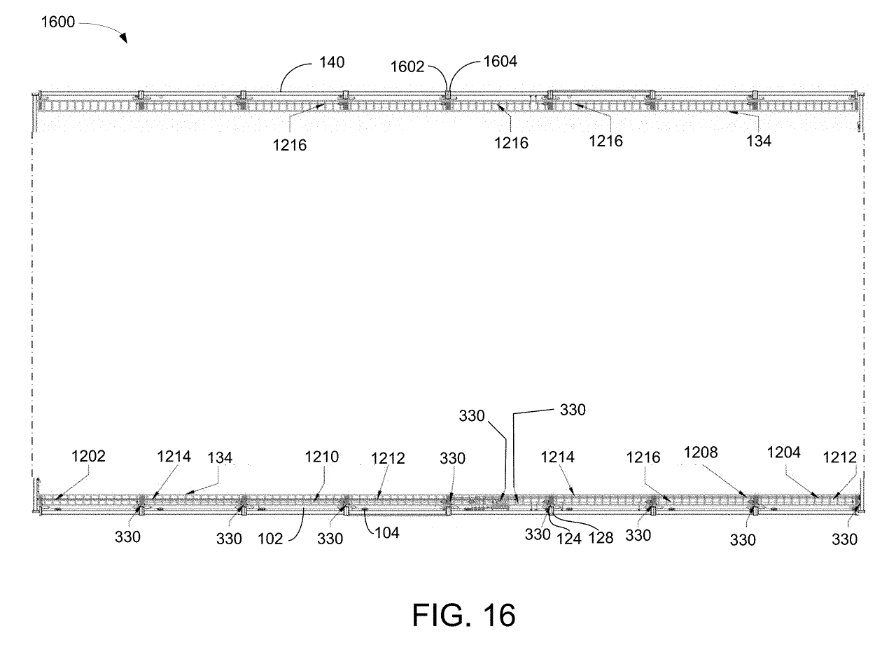

FIG. 16 is a side elevation view through section FF 1600 illustrating an exemplary embodiment of the cable tray 134 of the exemplary plug and play folding building system 100 of FIG. 1, according to a preferred embodiment of the present invention. FIG. 16 is essentially a downward view onto the cable trays 134 on opposing walls of the plug and play folding building system 100. the various cables in the cable trays are identified. Wall column 1602 and 1604 of adjoining wall panels are joined together by bolts. Prewired lighting circuit main 102 is shown supported on the wall panels, along with prewired electrical T-couplings 104 (one of eight labeled).

Although applicant has described applicant's preferred embodiments of this invention, it will be understood that the broadest scope of this invention includes such modifications as diverse shapes and sizes and materials. Such scope is limited only by the above specification and the claims below.

An advantage of the present invention is that prewiring is done on foldable building sections. Another advantage of the present invention is increased speed and reduced cost of assembly. Yet another advantage is that plug and play connectors 330 between foldable building sections have enough slack cabling ends to enable the connectors to be stowed during transport, storage, and the initial stages of building assembly. Yet another advantage is that plug and play connectors 330 between foldable panels within the foldable building sections have enough slack cabling ends to enable the connectors to be stowed during transport, storage, and the initial stages of building assembly. Yet another advantage is that connecting the plug and play connectors 330 at the work site does not require an electrician. Further, many other advantages of applicant's invention will be apparent to those skilled in the art from the above descriptions.

I claim:

1. A plug and play folding building system comprising:
a. a plurality of four-panel foldable building sections, each having factory-installed electrical wiring on at least adjacent first and second said panels of at least one said four-panel foldable building section of said plurality of four-panel foldable building sections;
b. a first male portion of a plug and play connector connected to a slack end of a first electrical cable of said factory-installed electrical wiring on said first panel;
c. a first female portion of said plug and play connector connected to a slack end of a second electrical cable of said factory-installed electrical wiring on said second panel; and
d. wherein said first male and said first female portions are adapted to be:
i. stowed within said four-panel foldable building section during transportation and storage; and
ii. deployed and connected during installation of said four-panel foldable building section.

2. The system of claim 1, comprising;
a. a second male portion of a second plug and play connector connected to a slack end of a third electrical cable of said factory-installed electrical wiring on said first panel of a first four-panel foldable building section of said plurality of four-panel foldable building sections;
b. a second female portion of said second plug and play connector connected to a slack end of a fourth electrical cable of said factory-installed electrical wiring on said first panel of a second four-panel foldable building section of said plurality of four-panel foldable building sections;
c. where said first and second four-panel foldable building sections are adjacent and aligned when installed; and
d. wherein said second male and second female portions are adapted to be:
i. stowed within said first and second four-panel foldable building sections, respectively, during transportation and storage; and
ii. deployed and connected during installation of said first and second four-panel foldable building sections.

3. The system of claim 2, comprising at least one panel of at least one four-panel foldable building section of said plurality of four-panel foldable building sections having a plurality of plug and play electrical connector portions adapted to connect to a field-installable distribution block having an equal said plurality of complimentary plug and play electrical connector portions.

4. The system of claim 2, comprising at least one panel of at least one four-panel foldable building section of said plurality of four-panel foldable building sections having:
a. a factory-installed lighting fixture; and
b. a factory-installed convenience power outlet.

5. The system of claim 2, comprising at least one panel of at least one four-panel foldable building section of said plurality of four-panel foldable building sections having a plug and play electrical connector portion adapted to connect to a primary power source.

6. The system of claim 2, comprising;
a. at least one panel of at least one four-panel foldable building section of said plurality of four-panel foldable building sections having a plug and play electrical connector portion connected to a slack end of a fifth cable and adapted to connect to a complimentary portion of said plug and play electrical connector on at least one side end panel having factory-installed electrical wiring; and
b. said end panel comprising said complimentary plug and play electrical connector portion connected to a slack end of a sixth electrical cable of said factory-installed electrical wiring and adapted to be:
i. stowed within said at least one side end panel during transportation and storage; and
ii. deployed and connected during installation of said at least one side end panel.

7. The system of claim 6, comprising said at least one side end panel further comprising at least one of:
a. a personnel access door;
b. prewired indoor exit sign coupled to a plug and play connector portion;
c. a prewired fan coupled to a plug and play connector portion;
d. prewiring for a field-installable roll-up door motor coupled to a plug and play connector portion;
e. prewiring for an external personnel access door light coupled to a plug and play connector portion;
f. prewiring for an external service door light coupled to a plug and play connector portion;
g. a prewired door motor switch; and
h. a small service door.

8. The system of claim 6, comprising:
a. first and second top end panels adapted to support a field installable roll up door;
b. a side end panel adapted to support a field installable rollup door motor.

9. The system of claim 2, comprising:
a. a plurality of field installable cable tray brackets adapted to be attached to adjacent pairs of columns in an interior of a building assembled from said plurality of four-panel foldable building sections;
b. first and second field installable cable trays supportable on said cable tray brackets when said brackets are installed, wherein said first and second cable trays have openings in bottom surfaces of said cable trays large enough to enable plug and play connector portions to extend there through; and
c. a plurality of cable tray cables fitted with plug and play connector portions at opposing slack ends of each said cable tray cable of said plurality of cable tray cables.

10. The system of claim 9, wherein said first and second field installable cable trays extend for the lengths of first and second opposing walls of said building, when installed.

11. A plug and play folding building system comprising:
a. a plurality of four-panel foldable building sections, each having factory-installed electrical wiring on at least adjacent first and second said panels of said four-panel foldable building section of said plurality of said four-panel foldable building sections;
b. a first male portion of a plug and play connector connected to a slack end of a first electrical cable of said factory-installed electrical wiring on said first panel;
c. a first female portion of a plug and play connector connected to a slack end of a second electrical cable of said factory-installed electrical wiring on said second panel; and
d. wherein said first male and first female portions are adapted to be:
i. stowed within said four-panel foldable building section during transportation and storage; and
ii. deployed and connected during installation of said four-panel foldable building section.
e. a second male portion of a second plug and play connector connected to a slack end of a third electrical cable of said factory-installed electrical wiring on said first panel of a first four-panel foldable building section of said plurality of four-panel foldable building sections;
f. a second female portion of said second plug and play connector connected to a slack end of a fourth electrical cable of said factory-installed electrical wiring on said first panel of a second four-panel foldable building section of said plurality of four-panel foldable building sections;
g. where said first and second four-panel foldable building sections are adjacent and aligned when installed; and
h. wherein said second male and second female portions are adapted to be:
i. stowed within said first and second four-panel foldable building sections, respectively, during transportation and storage; and
ii. deployed and connected during installation of said first and second four-panel foldable building sections.

12. The system of claim 11, comprising:
a. at least one panel of at least one four-panel foldable building section of said plurality of four-panel foldable building sections having a plurality of plug and play electrical connector portions adapted to connect to a field-installable distribution block having an equal said plurality of complimentary plug and play electrical connector portions;
b. at least one panel of at least one four-panel foldable building section of said plurality of four-panel foldable building sections having:
i. a factory-installed lighting fixture; and
ii. a factory-installed convenience power outlet.

13. The system of claim 11, comprising at least one panel of at least one four-panel foldable building section of said plurality of four-panel foldable building sections having a plug and play electrical connector portion adapted to connect to a primary power source.

14. The system of claim 11, comprising;
a. at least one panel of at least one four-panel foldable building section of said plurality of four-panel foldable building sections having a third plug and play electrical connector portion connected to a slack end of a fifth cable and adapted to connect to a complimentary portion of said third plug and play electrical connector on an end panel having factory-installed electrical wiring; and
b. said end panel comprising said complimentary plug and play electrical connector portion connected to slack end of a sixth electrical cable of said factory-installed electrical wiring and adapted to be:
i. stowed within said end panel during transportation and storage; and
ii. deployed and connected during installation of said end panel.

15. The system of claim 14, comprising said end panel further comprising at least one of:
a. a personnel access door;
b. prewired indoor exit sign coupled to a plug and play connector portion;
c. a prewired fan coupled to a plug and play connector portion;
d. prewiring for a field-installable roll-up door motor coupled to a plug and play connector portion;
e. prewiring for an external personnel access door light coupled to a plug and play connector portion;
f. prewiring for an external service door light coupled to a plug and play connector portion;
g. a prewired door motor switch; and
h. a small service door.

16. The system of claim 14, comprising:
a. first and second top end panels adapted to support a field installable roll up door;
b. a side end panel adapted to support a field installable rollup door motor.

17. The system of claim 11, comprising:
a. a plurality of field installable cable tray brackets adapted to be attached to adjacent pairs of columns in an interior of a building assembled from said plurality of four-panel foldable building sections;
b. first and second field installable cable trays supportable on said cable tray brackets when said brackets are installed, wherein said first and second cable trays have openings in bottom surfaces of said cable trays large enough to enable plug and play connector portions to extend there through; and
c. a plurality of cable tray cables fitted with plug and play connector portions at opposing slack ends of each said cable tray cable of said plurality of cable tray cables.

18. A plug and play folding building system comprising:
a. a plurality of four-panel foldable building sections, each having factory-installed electrical wiring on at least a first said panel of a first four-panel foldable building section of said plurality of four-panel foldable building sections;
b. a first male portion of a plug and play connector connected to a slack end of a first electrical cable of a factory-installed electrical wiring on said at least one first panel of said first four-panel foldable building section of said plurality of four-panel foldable building sections;
c. a first female portion of a plug and play connector connected to slack end of a second electrical cable of said factory-installed electrical wiring on said at least one first panel of a second four-panel foldable building section of said plurality of four-panel foldable building sections;
d. where said first and second four-panel foldable building sections are adjacent and aligned when installed; and
e. wherein said first male and first female portions are adapted to be:
i. stowed within said first and second four-panel foldable building sections, respectively, during transportation and storage; and
ii. deployed and connected during installation of said first and second four-panel foldable building sections.

19. The system of claim 18, comprising:
a. a second male portion of a plug and play connector connected to a slack end of a third electrical cable of said factory-installed electrical wiring on said first panel of said first four-panel foldable building section of said plurality of four-panel foldable building sections;
b. a second female portion of a plug and play connector connected to a slack end of a fourth electrical cable of said factory-installed electrical wiring on a second adjacent panel of said four-panel foldable building section of said plurality of four-panel foldable building sections; and
c. wherein said second male and second female portions are adapted to be:
i. stowed within said four-panel foldable building section during transportation and storage; and
ii. deployed and connected during installation of said four-panel foldable building section.

20. The system of claim 19, comprising:
a. at least one panel of at least one four-panel foldable building section of said plurality of four-panel foldable building sections having a plurality of plug and play electrical connector portions adapted to connect to a field-installable distribution block having an equal said plurality of complimentary plug and play electrical connector portions;
b. at least one panel of at least one four-panel foldable building section of said plurality of four-panel foldable building sections having:
i. a factory-installed lighting fixture; and
ii. a factory-installed convenience power outlet;
iii. at least one panel of at least one four-panel foldable building section of said plurality of four-panel foldable building sections having a plug and play electrical connector portion adapted to connect to a primary power source;
c. at least one panel of at least one four-panel foldable building section of said plurality of four-panel foldable building sections having a third plug and play electrical connector portion connected to a slack end of a fifth cable and adapted to connect to a complimentary portion of said third plug and play electrical connector on an end panel having factory-installed electrical wiring; and
d. said end panel comprising said complimentary third plug and play electrical connector portion connected to a slack end of a sixth electrical cable of said factory-installed electrical wiring and adapted to be:
i. stowed within said end panel during transportation and storage; and
ii. deployed and connected during installation of said end panel;
e. wherein said end panel further comprises at least one of:
i. a personnel access door;
ii. prewired indoor exit sign coupled to a plug and play connector portion;
iii. a prewired fan coupled to a plug and play connector portion;
iv. prewiring for a field-installable roll-up door motor coupled to a plug and play connector portion;
v. prewiring for an external personnel access door light coupled to a plug and play connector portion;
vi. prewiring for an external service door light coupled to a plug and play connector portion;
vii. a prewired door motor switch; and
viii. a small service door;
f. first and second top end panels adapted to support a field installable roll up door; and
g. a side end panel adapted to support a field installable rollup door motor.
